(19) United States
(12) Patent Application Publication
(10) Pub. No.: US 2014/0052480 A1
(43) Pub. Date: Feb. 20, 2014

(54) VOICE ACTIVATED DATABASE MANAGEMENT VIA WIRELESS HANDSET

(71) Applicant: Pilot Catastrophe Services, Inc., Mobile, AL (US)

(72) Inventors: John C. Bell, Mobile, AL (US); Colm M. Keenan, Middleton, WI (US)

(73) Assignee: Pilot Catastrophe Services, Inc., Mobile, AL (US)

(21) Appl. No.: 13/969,329

(22) Filed: Aug. 16, 2013

Related U.S. Application Data
(60) Provisional application No. 61/684,630, filed on Aug. 17, 2012.

(51) Int. Cl. G06Q 40/08

(52) U.S. Cl. CPC G06Q 40/08
USPC 705/4

(57) ABSTRACT

An insurance claim report generating system includes an interactive voice response (IVR) system, a voice recognition server, and a voice activated database (VAD) device. The IVR system receives telephone calls from remote devices, delivers audio scripts having prompts directed by both templates and data received from the remote devices. The IVR system receives dual-tone, multi-frequency (DTMF) information and human voice information in response to the prompts. The voice recognition server generates text from the human voice information using a dictionary of insurance relevant terms. The VAD device receives first digital information from the IVR system and second digital information from the voice recognition server. The first digital information is derived from the DTMF information, and the second digital information is derived from the human voice information. The VAD device generates an insurance claim report from at least some of the first or second digital information.

### BACKGROUND

1. Technical Field

The present disclosure generally relates to improving the efficiency of an insurance adjuster's claim report drafting process and more particularly, but not exclusively, relates to improving the efficiency of an insurance adjuster working at the site of a calamity by providing a wirelessly accessible, voice enabled database management tool.

2. Description of the Related Art

Insurance claims adjusters create reports based on their interactions with customers. The reports are published to different business units, locations, entities, etc. according to insurance provider policy. The reports can include answers to basic Yes/No questions, dictation based diary entries, summary statements, sketches, photographs, and other information. The reports are conventionally created by hand with a pencil and paper. In some cases, the insurance claims adjuster transcribes previously handwritten notes into a computer to create an electronic report copy. The electronic report is stored in a database and treated as a foundational document for an insurance claim. The information contained in the electronic report is used to open an insurance claim, process the insurance claim, and subsequently close the insurance claim.

FIG. 1 is a flowchart 1 illustrating a conventional insurance claim report generation method. Processing begins at 2. At 3, an insurance adjuster visits the site of a calamity. The adjuster, using a pen and paper, records information related to what the adjuster observes, hears, and infers from the onsite visit. At 4, which occurs at some point during or after the onsite visit, the adjuster transcribes the handwritten notes into electronic form by inputting data into a computer. Electronic reports are generated by a computer from the entered data at 5, and later, at 6, the electronic reports are sent to other entities. Processing ends at 7.

### BRIEF SUMMARY

Insurance adjusters produce conventional electronic insurance claim reports from handwritten notes. The notes are transcribed into electronic claim reports, and the reports are sent via electronic mail or electronic facsimile (fax) to an insurance provider for processing.

The conventional method of producing and sending an electronic insurance report is now replaced with a new electronic insurance claim report method that includes configuring an interactive voice response (IVR) system to receive a telephone call from a remote device and deliver an audio script having prompts in response to the received telephone call. In response to data received from the remote device, prompts associated with an insurance claim report generation template are output. Dual-tone, multi-frequency (DTMF) signaling tone information and human voice information is received in response to the prompts. The new electronic insurance claim report method also includes configuring a voice recognition server to generate text from human speech, the voice recognition server having access to a dictionary that includes insurance relevant terms. A voice activated database (VAD) device is also configured. The VAD device is configured to (1) receive first digital information from the IVR system, the first digital information derived from the DTMF signaling tone information, (2) receive second digital information from the voice recognition server, the second digital information derived from the human voice information passed through the voice recognition server, and (3) generate the electronic insurance claim report from at least some of the first or second digital information. Additionally, the new electronic insurance claim report method communicates the electronic insurance claim report to a claims management device.

In a first embodiment, an electronic insurance claim report method includes the acts of configuring an interactive voice response (IVR) system to receive a telephone call from a remote device, deliver, to the remote device, an audio script having prompts in response to the received telephone call and in further response to data received from the remote device, the prompts associated with an insurance claim report generation template, and receive at least one of dual-tone, multi-frequency (DTMF) signaling tone information and human voice information in response to the prompts. The method will also configure a voice recognition server to generate text from human speech, the voice recognition server having access to a dictionary that includes insurance relevant terms. The method will further configure a voice activated database (VAD) device to receive first digital information from the IVR system, the first digital information derived from the DTMF signaling tone information, receive second digital information from the voice recognition server, the second digital information derived from the human voice information passed through the voice recognition server, and generate the electronic insurance claim report from at least some of the first or second digital information. The electronic insurance claim report will be communicated to a claims management device.

In a second embodiment, an insurance claim report generating system includes an interactive voice response (IVR) system, a voice recognition server, and a voice activated database (VAD) device. The IVR system is configured to receive a telephone call from a remote device, deliver an audio script having prompts directed by both an insurance claim report generation template and data received from the remote device, and receive at least one of dual-tone, multi-frequency (DTMF) signaling tone information and human voice information in response to the prompts. The voice recognition server is configured to generate text from the human voice information, the voice recognition server having access to a dictionary of insurance relevant terms. The voice activated database (VAD) device is configured to receive first digital information from the IVR system and second digital information from the voice recognition server. The first digital information is derived from the DTMF signaling tone information, and the second digital information is derived from the human voice information passed through the voice recognition server. The VAD device is further configured to generate an insurance claim report from at least some of the first or second digital information.

Another embodiment includes a non-transitory computer readable storage medium whose stored contents configure a computing system to perform a method. The method includes the acts of receiving a telephone call from a remote device, delivering, to the remote device, an audio script having prompts in response to the received telephone call and in further response to data received from the remote device. The prompts are associated with an insurance claim report generation template. The method also includes the acts of receiving at least one of dual-tone, multi-frequency (DTMF) signaling tone information and human voice information in response to the prompts, and generating, with a voice recognition server, text from human speech, the voice recognition server having access to a dictionary that includes insurance relevant terms. The method includes receiving first digital information derived from the DTMF signaling tone information, receiving second digital information from the voice recognition server, the second digital information derived from the human voice information passed through the voice recognition server, and generating an electronic insurance claim report from at least some of the first or second digital information.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a flowchart illustrating a conventional insurance claim report generation method;

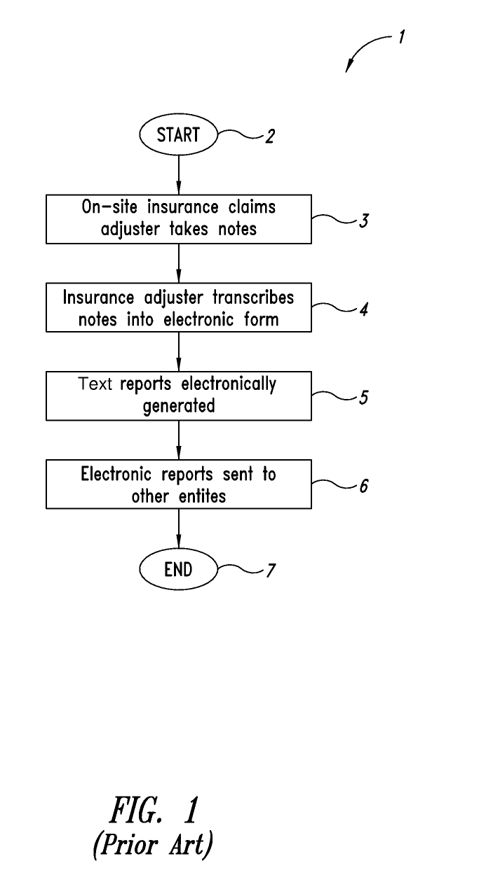

FIG. 2A illustrates several devices configured together to form a wireless, voice enabled database management tool;

FIG. 2B is a flowchart illustrating acts corresponding to operations of the wireless, voice enabled database management tool of FIG. 2A;

FIG. 3 illustrates another embodiment of a wireless, voice enabled database management tool; and

FIG. 4 is a flowchart illustrating acts corresponding to operations of the wireless, voice enabled database management tool of FIG. 3

### DETAILED DESCRIPTION

The conventional methodology used to generate an electronic insurance claim report is inefficient and allows typographical and other errors to be introduced into the electronic reports. In the conventional method, an insurance adjuster visits the site of a calamity and takes time to hand write notes based on what is observed, heard, felt, touched, and perceived at the site. Subsequently, the adjuster takes additional time for manual entry of data into a computer. If the data taken from the handwritten notes is inaccurately entered, then the electronic report will contain inaccurate data, which may not even be later correctable.

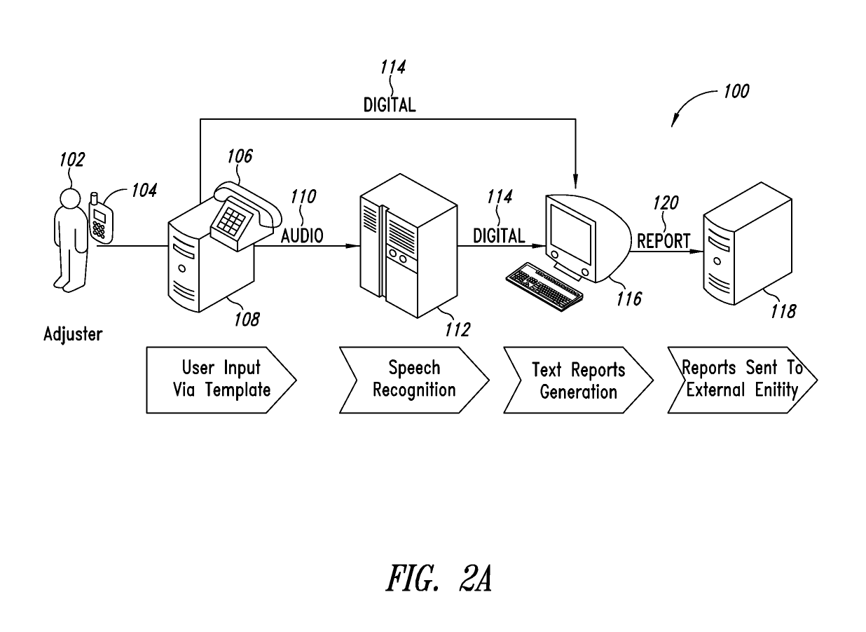

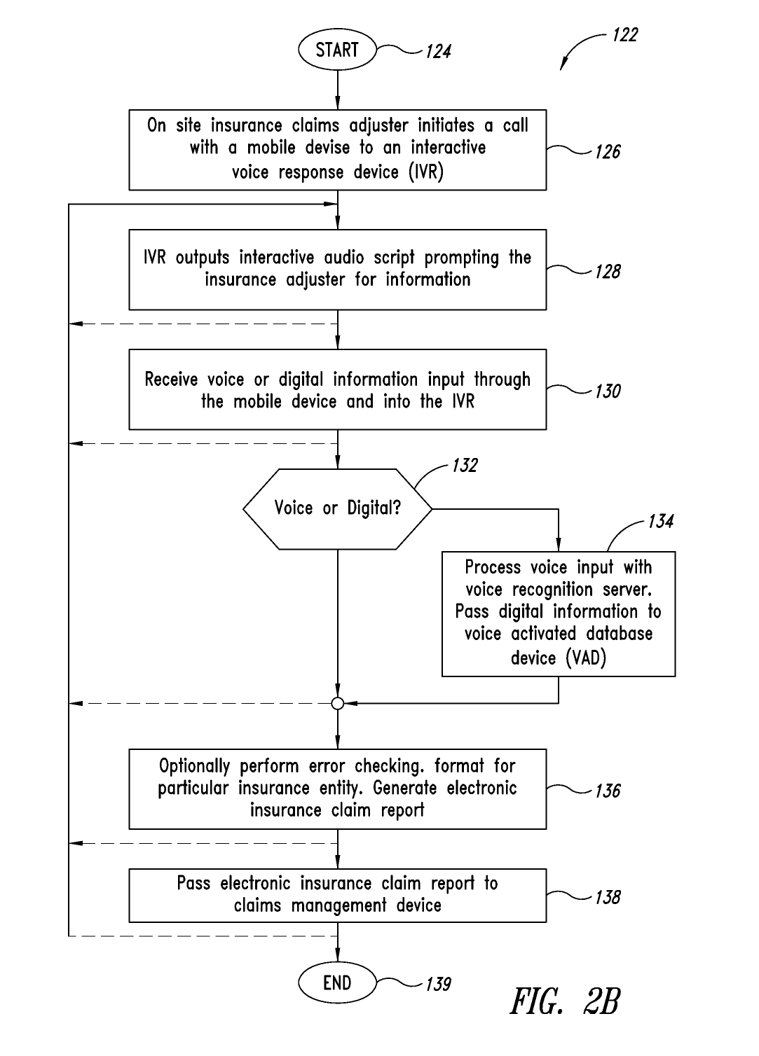

The present disclosure provides new devices and a new method to generate electronic insurance claim reports in a more accurate and efficient way. FIG. 2A illustrates several devices configured together to form a wireless, voice enabled database management tool 100. FIG. 2B is a flowchart illustrating acts corresponding to operations of the wireless, voice enabled database management tool 100 of FIG. 2A.

The system 100 of FIG. 2A includes an interactive voice response (IVR) device 108 that operates according to a predefined template and user input, a voice recognition server 112 to convert speech to text, a voice activated database (VAD) device 116 to generate text reports, and an external claims management device 118, which collects, processes, and distributes the data communicated from the VAD device 116.

A claims adjuster 102 is illustrated in FIG. 2A. The claims adjuster 102 uses a mobile device 104 to communicate with the IVR device 108. The IVR device 108 includes hardware and software electronic logic modules configured to allow a human (e.g., a claims adjuster 102) to interact with a computer. For example, the IVR device 108 may include components of a modified private branch exchange (PBX) system. The IVR device 108 permits the human to place a telephone call to the IVR device 108. On the call, the human can press telephone buttons to pass dual-tone, multi-frequency (DTMF) signaling tones, or the human can speak voice commands and data into the IVR device 108 in response to voice prompts produced by the IVR device 108.

The IVR device 108 can pass digital information 114, which may for example include answers to “Yes/No” questions, answers to multiple choice questions, numbers, and other information compatible with pressing telephone keypad buttons. The digital information is passed to the VAD device 116. Additionally, the IVR device 108 can pass human voice information 110 to the voice recognition server 112, and the voice recognition server 112 creates additional digital information 114, which is passed to the VAD device 116.

The VAD device 116 generates a text based transcript of the telephone call initiated by the adjuster 102. The VAD device 116 also generates an electronic insurance claim report 120. Prior to creating the electronic insurance claim report 120, the transcript is reviewed for correctness and formatted for entry into a claims management device 118. Review of the transcript can be performed by a human or electronically. For example, the transcript can be reviewed via a web-based portal, a directly coupled display device, a non-web based network, a printer, or by some other means. In other cases, the transcript may be reviewed by an electronic system that parses the information to detect errors. A review of the transcript provides an opportunity to correct information and cross-reference or otherwise correlate information to verify its accuracy. The complete voice recording and the transcript are stored in their entirety and in some cases, compressed, encrypted, or otherwise encoded before being stored.

The electronic insurance claim report 120 may take any form acceptable by the claims management device 118. Once accepted by the claims management device 118, the insurance claim can be processed by the associated insurance provider in a known manner, which is not further described.

Typically, the claims management device 118 is provided and administered by an entity that provides insurance to customers. The entity associates itself with insurance claims adjusters, and the associated adjusters are allowed to submit electronic insurance claim reports 120 to the claims management device 118 of the insurance entity. The claims management device 118 of one insurance entity is typically different from the claims management device 118 of another entity. Accordingly, each claims management device 118 typically requires an electronic insurance claim report to have a particular format that is different from the format of another different claims management device 118. In some embodiments, the VAD device 116 is configured to produce electronic insurance claim reports 120 of many different formats, and thus, the VAD device 116 may be coupled to several different claims management devices 118.

As represented in the flowchart of FIG. 2B, an insurance claims adjuster 102 uses a wireless, voice enabled database management tool 100 in a process 122. At 124, the process begins. At 126, an insurance claims adjuster initiates a telephone call with an interactive voice response (IVR) device. The insurance adjuster will often use a mobile device to make the telephone call from the site of a calamity. In some cases, the insurance adjuster may enter identification (ID) information, a personal ID number (PIN), or other information to obtain permission to use the database management tool 100. In some cases, the insurance adjuster may also enter a claim number or claim type indicator to direct the IVR device to select a desired script template.

The IVR device at 128 outputs interactive audio prompts in the form of a script. For example, the IVR device requests information related to an active or prospective insurance claim from the insurance adjuster. At 130, the IVR accepts input from the insurance adjuster via the mobile device. The insurance adjuster may speak the information in certain cases or alternatively, the insurance adjuster may use a keypad or other input of the mobile device to enter the information. For example, a touch screen, a motion sensor in the mobile device, a photograph taken, a tap on the device, and the like may also be used to input data. At 132, the IVR system distinguishes voice input (i.e., as spoken by the insurance adjuster) from digital input (e.g., signaling DTMF tones from keypad input, touch screen input, etc.).

If the input is digital input, the digital input is passed to the voice activated database (VAD) for processing. If the input is voice input, then the audio voice information is passed to a voice recognition server. At 134, the voice recognition server analyzes the voice data and generates understandable text. The understandable text, which is generated as computer recognizable data, is passed to the VAD for processing.

At 136, the VAD processes the digital information. The digital information may be reviewed and error checked. For example, a human may review the digital information via a web portal or other interface and edit the digital information. As another example, a software program automatically reviews the digital information and identifies typographical errors, mis-matched data, incomplete information, and other anomalies. The software program may correct some or all of the anomalies or the software program may urge a human (e.g., the claims adjustor, a claims processor, or the like), via an output indicator, to correct the anomalies. An electronic insurance claim report is generated by the VAD, the report having a format compatible with a particular claims management device administered by an insurance entity. The electronic insurance claim report is passed to the claims management device at 138, and at 139, processing ends.

The process 122 of FIG. 2B illustrates several optional paths of processing back to the input of act 128. The optional paths illustrate the flexibility of process 122 wherein several modules, devices, and systems of the process may operate with some autonomy. In particular, some parts of the process optionally continue advancing the process while other parts return control back to the IVR where the audio script continues to prompt the insurance adjuster for additional information. The IVR, which may also operate with some autonomy, follows the particular script to continuously determine a next prompting question while the process is operating. The information received in response to the prompt is advanced according to process 122.

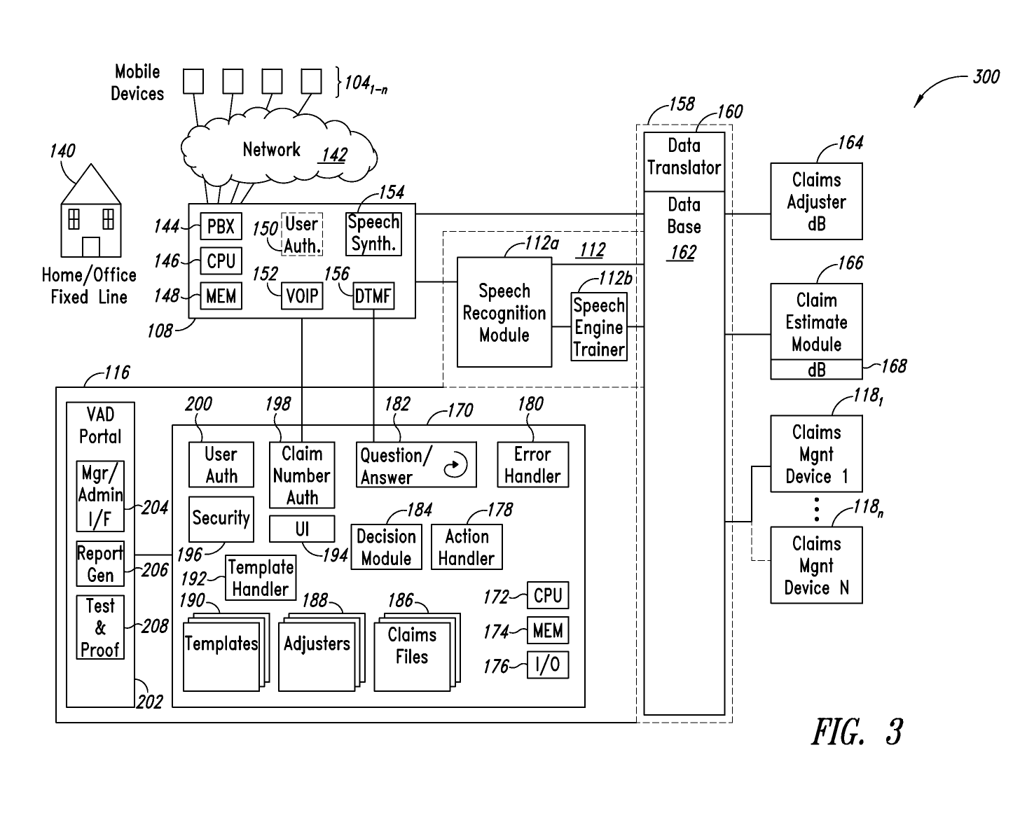

FIG. 3 illustrates another embodiment of a wireless, voice enabled database management tool 300. With corresponding reference to the tool 100 of FIG. 2A, the tool 300 of FIG. 3 receives information via a plurality of mobile devices 104₁-104_{N}. The mobile devices 104₁-104_{N} are operated by a plurality of insurance adjusters (not shown) working at the sites of one or more calamities to collect insurance claim data. Also in correspondence to FIG. 2A, the mobile devices 104₁-104_{N} of FIG. 3 pass information to a voice activated database (VAD) device 116 through an interactive voice response (IVR) device 108 and a voice recognition server device 112. The VAD device 116 of FIG. 3 generates electronic insurance claim reports passed to one or more claims management devices 118₁-118_{N}. The VAD device 116, IVR device 108, and a voice recognition server device 112 of the wireless, voice enabled database management tool 300 of FIG. 3 are described in more detail.

An office entity 140 embodiment administers the VAD device 116 of the wireless, voice enabled database management tool 300 of FIG. 3. In some embodiments, the VAD device 116 optionally shares hardware and software modules with the voice recognition server 112, illustrated with a dashed boundary line. In some embodiments, the VAD device 116 optionally shares hardware and software modules with a database system 158, illustrated with a dashed boundary line. It is also understood that the VAD device 116 may share hardware and software modules with the IVR device 108 in some embodiments. In other embodiments, one or more of the IVR devices 108, VAD devices, 116, voice recognition servers 112, and database systems 158 are formed with separate and distinct computing resources. The voice recognition server 112, for example, is sometimes installed on a separate computing server device.

Speech recognition is a resource intensive process, particularly when there are multiple audio streams to be processed and transcribed concurrently. In such embodiments, the voice recognition server 112 is configured to communicate with the database system 158. The database system 158 is also sometimes installed on a separate computing server device based, at least in part, on the volume and demand for use of the database services.

The interactive voice response (IVR) device 108 embodiment of FIG. 3 includes a central processing unit (CPU) 146 and memory 148. Other hardware and software modules of the IVR device 108 are not illustrated for the sake of simplicity. In cooperation, the CPU 146 and memory 148 carry out the acts that provide the functional modules of IVR device 108. The IVR device 108 embodiment includes a private branch exchange module 144, an optional user authorization module 150, a voice over Internet protocol (VOIP) module 152, a speech synthesis module 154, and a dual-tone, multi-frequency (DTMF) module 156.

The IVR device 108 provides an interface to insurance adjusters that are presently or recently at the site of a calamity. That is, to an insurance adjuster working at a prospective or known claim site, the IVR device 108 provides a means for the adjuster to “call the office” 140 and submit claim report information. The insurance adjuster typically uses a mobile device 104₁-104_{N} to initiate a telephone call through the network 142. The telephone call is connected with the IVR device 108 via a PBX module 144.

Embodiments of the IVR device 108 may include an optional user authentication module 150. In such embodiments, the IVR device 108, which is the interface to the claims adjusters, can validate the identity and reject or approve permission to the claims adjuster (or other party) that initiated a call to the IVR device 108. The user authentication module 150 may import adjuster information directly from a certain database system 158. Alternatively, the user authentication module 150 may receive adjuster information from the VAD device 116. The adjuster information may include a system unique ID, a personal information number (PIN), or other data. The adjuster information may be system generated or configured by the user (e.g., a claims adjuster enters a private ID number, PIN). The adjuster information will be linked to transcripts, audio recordings, and other information associated with the particular insurance adjuster.

Embodiments of PBX module 144 operate as a telephone exchange that provides service to the office 140. The PBX telephony system may be constituted entirely in software, hardware, or a combination of software and hardware. The PBX module 144 embodiments carry out trees, conditional logic, state machines, script driven processes, and other like operations in additional to the regular feature sets expected to be provided by a PBX module (e.g., multiple lines, call routing, etc.). The PBX module 144 of FIG. 3 can cooperate with the VOIP module 152 to provide digital and voice telephony services within the IVR device 108.

The PBX module 144 may further cooperate with a speech synthesis engine 154. This speech synthesis engine 154 allows for scripted voice prompts to be announced to an insurance claims adjuster. For example, the VAD device 116 may direct the speech synthesis engine 154 to customize a script or automated call with the name of the insured party, the name of the claims adjuster, or other information that is to be voiced during the telephone call. In some embodiments, a script resident in the IVR device 108 executes for every received call. Subsequent scripts are then voiced based on a template chosen after the caller provides some initial input.

In addition to inbound calls, the IVR device 108 may perform outbound calls through the PBX module 144. In such cases, the speech synthesis engine 154 also voices the scripts of automated calls scheduled based on predefined templates provided by the VAD device 116. The automated calls are triggered by certain predetermined answers to report templates during an existing call, or the automated calls can be triggered upon other user input.

Input to the IVR device 108 may be voice information received via the PBX, processed, and passed to the VAD device 116 directly or by way of the voice recognition server 112. Alternatively, or in addition, input to the IVR device 108 may include signal tones entered as key input by the claims adjuster through a mobile device 104. In the case of key input information, the IVR device 108 includes a DTMF module arranged to interpret the signaling tones and produce digital information, which is passed to the VAD device 116. In the case of voice information, the audio data is passed to a voice recognition server 112. Other input to the IVR device may come from other information entered or captured by the mobile device 104 and passed to the IVR device 108 as digital command or data information such as electronic text messages (Short Message Service), electronic mail of a particular format, or other digital commands and data.

The voice recognition server 112 accepts audio as an input and decodes the audio to generate text or encoded digital information as an output. In some cases, the voice recognition server 112 stores one or both of the raw audio files and the decoded text transcript in the database system 158. In other cases, the VAD device 116 performs the storage of raw and decoded voice data. The stored data files are named or otherwise encoded in a manner that identifies bibliographic information about the data; for example, date, time, adjuster's identity, claim number, file content subject matter, and the like.

The voice recognition server 112 includes a speech recognition module 112a and an optional speech engine trainer 112b. The speech recognition module 112a converts an acoustic signal (i.e., the voice information audio data) to a textual set of words. To convert speech to text, embodiments of the speech recognition module 112a digitize the sound and pass the digital signal through preset filters to achieve a desired digital sound signal. This signal is then split into small segments and the segments are matched to known (e.g., English, Spanish, Chinese, etc.) phonemes. The program also compares the matched phonemes to the other determined phonemes using a complex statistical model and a large dictionary to determine what the adjuster has said. The dictionary includes particular words and phrases consistent with insurance industry vernacular. The speech recognition module 112a can be configured to interpret voice input from many different languages, which can eliminate or reduce the number of errors for non-native speaking insurance adjusters.

Embodiments of the speech recognition module 112a permit continuous speech recognition. That is, the adjuster is permitted to speak in natural language in real time, and the adjuster is not restricted to a particular vocabulary. When continuous speech is spoken by the adjuster, the speech recognition module 112a uses language models or artificial grammars, in cooperation with the associated dictionary, to generate suitable combination of words and ignore or flag others.

The voice recognition server 112 may include an optional speech engine trainer 112b. In some embodiments, the speech recognition module 112a is speaker-independent, and no training is necessary. In other cases, some or all of the insurance adjusters can provide speech samples, to the speech engine trainer 112b, and the trainer is adapted to recognize the speech patterns and nuances of the particular adjuster. The optional speech engine trainer 112b, if it is included, can improve the speed at which an adjuster can accurately pass voice commands and information to the VAD device 116.

The database system 158 of FIG. 3 is illustrated as including a data translator module 160 and a database 162. This database system acts as a secure repository for data associated with the wireless, voice enabled database management tool 300. Various modules associated with the office 140 store and retrieve data from the database system 158, and various other external systems also store and retrieve data from the database system 158.

Data from external providers may be received as a dump file directly into the database system 158 or data may be obtained via web services or other networked services. In one embodiment, raw or processed data can be imported into the database system 158 via a database import script of the data translator 160, and the data may be stored in the database 162. Stored procedures of the data translator 160 may also be used to apply logic for picking selected data and retrieving them from the intended columns of the database 162. In one embodiment, the database 162 is administered as a MICROSOFT SQL SERVER database, and both standardized and customized queries to store, retrieve, interrogate, and others are stored and located in the data translation module 160.

Various external systems have access to database system 158 and interact with the VAD device 116 through the cooperative storage and retrieval of data in the database system 158. For example, three classes of such external systems are illustrated in FIG. 3 as a claims adjuster database 164, a claim estimation module 166 with associated database 168, and one or more claims management devices 118₁-118_{N}.

The claims adjuster database 164 is an external database administered by an insurance provider. The claims adjuster database 164 stores information associated with the insurance provider's business. In order to pass data efficiently, the claims adjuster database 164 and the database system 158 of the wireless, voice enabled database management tool 300 may be directly coupled, and customized scripts can be designed to permit the databases to share data.

The claim estimation module 166 and an associated claims estimation database 168 are operated to provide property claim estimation services to insurance providers. In some cases, the claim estimation module 166 is administered by an insurance provider, and in other cases, the claim estimation module is provided by a separate entity that services many insurance providers. The associated database 168 of the claim estimation module is a repository for storing claim estimate information.

The claims management devices 118₁-118_{N} communicate data to and from the database system 158. The management devices 118₁-118_{N} may also communicate data directly to and from the VAD device 116. Electronic insurance claim reports generated by the VAD device 116 are specifically formatted for a particular claims management device 118. In some embodiments, a VAD device 116 is configured to generate electronic insurance claim reports having at least two different formats, wherein each format is arranged according to a different insurance provider's specifications.

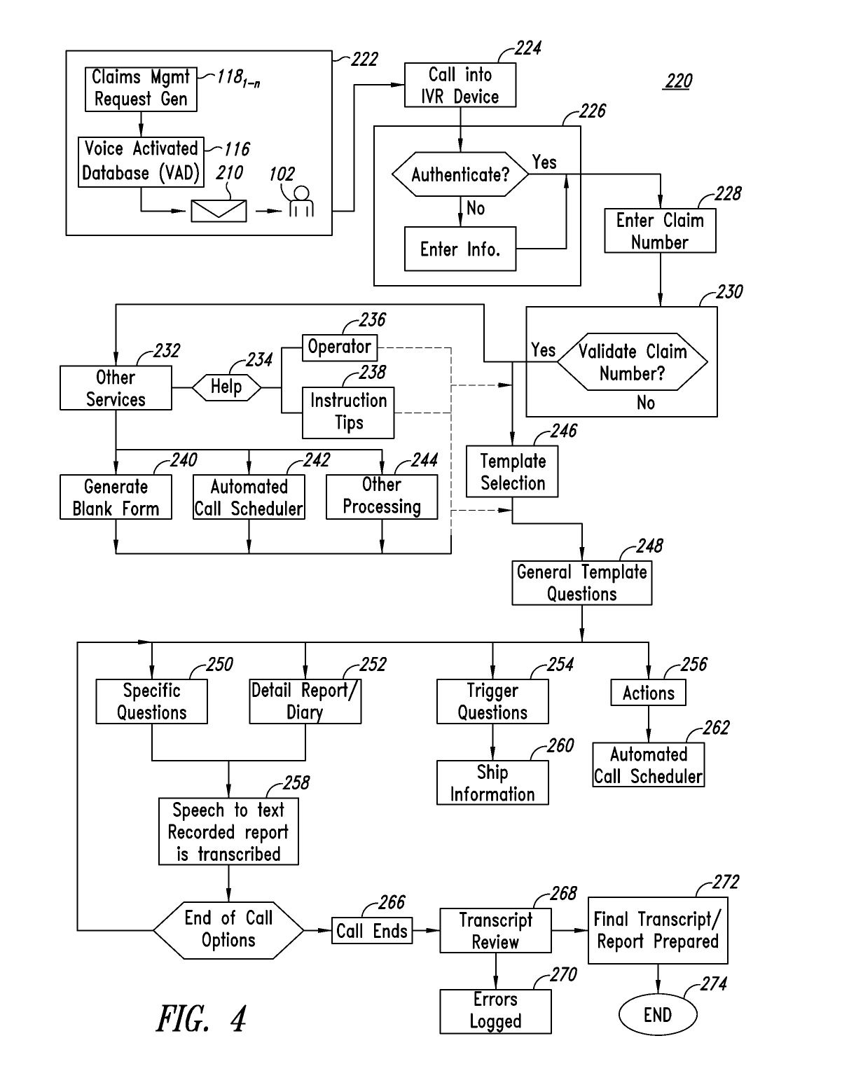

The VAD device 116 of FIG. 3 is illustrated in substantial detail. Specific modules of the VAD device 116 are described in composition and function with respect to FIG. 3, and particular inter-operations between modules of the VAD device 116 and operations between VAD device 116 modules and other modules are discussed with respect to FIG. 4.

The VAD device 116 includes a voice activated database (VAD) engine 170. The VAD engine 170 is a logical organization of hardware and software modules that provide substantial functionality of the VAD device 116. The modules of the VAD engine 170 may be provided in a single computing system or in a distributed computing system. At least one CPU 172 cooperates with memory 174 and input/output (I/O) module 176 to perform the functions of the VAD device 116. That is, the memory 174 may be configured as a non-transitory computer readable storage medium that stores instructions executed by the CPU 172. Embodiments of the VAD device 116 are carried out in a computing system wherein several tasks are concurrently carried out.

An action handler 178 handles independently occurring external actions triggered by the system. For example, particular transactions related to the database system 158 may involve data storage or retrieval actions from a voice recognition server 112, an IVR 108, or an external module (e.g., claim estimate module 166, claims management device 118, etc.). In such cases, the database may need to be made coherent with local data in the VAD device 116, or information being processed in the VAD device 116 may need to be updated. In another example, a request for processing on a new claim may be triggered by an input from a claims management device 118. Internal to the VAD system 116, the action handler 178 will also receive indications of triggered subroutines, alarmed or scheduled functions, data reviews, manually entered requests, template updates, and the like.

In response to certain indications, the action handler 178 may trigger other subroutines or perform other actions. In some embodiments, the action handler 178 can generate and send electronic mail (email) to a different insurance adjuster user or other party. The email can be generated according to a stored template.

An error handler 180 monitors and acts on errors that occur in the VAD engine 170. In some cases, the error handler 180 provides services to address system errors such as low memory conditions, loss of network connectivity, and the like. In additional or alternative cases, the error handler 180 provides services that are specific to a telephone call initiated by a claims adjuster. For example, the error handler may provide the responsive actions to the errors identified in Table 1.

TABLE 1
Error Conditions of the VAD Engine
Error encountered

| | |
|---|---|
| 1. | The user id cannot be identified. |
| 2. | The user PIN is invalid. |
| 3. | The claim number is invalid. |
| 4. | The claim number is not assigned to the adjuster. |
| 5. | The template chosen does not exist. |
| 6. | The database connection cannot be opened. |
| 7. | The speech recognition system cannot be queried. |
| 8. | The call is terminated before the End condition is met. |
| 9. | An expected response is not received; e.g. a phrase is |
| | received where a numeric response was expected. |

A question/answer task pump 182 is configured to operate as a task loop. While the VAD engine 170 is operating, the question/answer task pump 182 is polled, interrupted, or otherwise invoked when information arrives from a DTMF module 156 or a voice recognition server 112. In some cases, the question/answer module 182 operates as one or more state machines aware of the execution states of a particular script. As the script and corresponding state machine arrives at a point to wait for incoming information, digital information from the DTMF module 156 or voice recognition server 112 is analyzed to advance the script and state machine to a subsequent state. The output from the question/answer task pump 182 can be provided to a template handler 192, a decision module 182, the action handler 178, or another module.

The template handler module 192 administers the question/answer module 182. In some embodiments, the question/answer module 182 is implemented as a fast, low-level service that provides increased efficiency when processing many scripts. In other embodiments, the question/answer module 182 is integrated within the template handler module 192.

The template handler module 192 performs high level functions coordinated with the actions of the claims adjuster. When an adjuster initiates a call, the template handler 192 selects a template and moves the adjuster through the questions included in the template. Scripts are issued to the speech synthesis engine 154 for recitation to the adjuster. The scripts prompt the adjuster for selected information. The information from the adjuster is received as a response passed through the DTMF module 156 or voice recognition server 112 and accepted by the question/answer module 182. Some of the responsive information is processed by the question/answer module 182, and some is processed by the template handler 192. The information is passed to the decision module 182, the action handler 178, or another module.

The decision module 184 accepts input from the question/answer module 182 and additionally or alternatively, the decision module 184 accepts input from the template handler module 192. The decision module 184 will check the conditions of an action step called out in a template against the received input information. The decision module 184 will also interact with the database system 158 to run queries that check conditions for the selected template and that validate the ranges or accuracy of information entered by the claims adjuster. As input information is accepted, analyzed, validated, and otherwise processed, the decision module 184 will also output indicators to the state machine of the question/answer module 182 or template handler to advance the template and thereby further direct the data information input process for the claims adjuster.

In operation, the decision module 184 cooperates with other VAD device 116 modules to permit a claims adjuster to enter information. For example, a claims adjuster calls into the wireless, voice enabled database management tool 300, and the system identifies the adjuster. A template is chosen, and a script is “read” to the adjuster. A particular question can have multiple correct answers, and a next question to be asked can be based on how predefined conditions are applied to the information entered by the adjuster. The information entered by the adjuster is passed to the decision module 184, and the decision module 184 analyzes and performs checks on the information to determine what next step should be taken. An example, a next step in the template may include an instruction asking if an information pack has been provided. If the answer is yes, the template is advanced, and the script recites a next question. If the answer is no, the system creates a trigger for the shipment of the pack by passing it to the Action Handler 178. The processes of the template are executed until an End condition is encountered.

Another function of the template handler module 192 is a template creation function. In some cases, the templates are created outside of the VAD device 116 and imported into the VAD device 116. In other cases, certain functionality is provided by the template handler 192 that facilitates the creation and modification of templates. For example, in some embodiments, a visual template design function permits a user to create templates using a drag and drop flow chart based approach. In other embodiments, a user types in script language text, which is passed to the speech synthesis engine 154 during script execution. When the script is created for the template, certain trigger points are also created in the template to prompt a claims adjuster for input information.

The VAD device 116 includes, logically or physically, several areas of memory called out as particular storage repositories. The repositories may exist independently, in shared space, or in the database system 158. The repositories include a claims files memory 186, a claims adjuster identity memory 188, and a template memory 190.

The claims files memory 186 is configured to store data related to insurance claims. For example, final transcripts related to a claim are stored in the claims files memory 186. This memory is accessible via the VAD device 116 modules, and may also be accessible by other means, for example, supervisors, testing staff, and others that have administrative access to the raw data.

Data related to individual insurance claims adjusters may be stored in the claims adjusters identity memory 188. The data may include adjuster identification numbers, phone numbers, photographs, security information, contact information, a list of assigned claim numbers, and other data. Additional data related to claims adjusters may also be stored in the claims adjusters identity memory 188.

Templates and their associated claim information, scripts, and data, which are administered and processed by the template handler 192, are stored in a template memory 190 of the VAD device 116.

An optional user authorization module 200 is included in the VAD engine 170. When an insurance adjuster calls into the wireless, voice enabled database management tool 300, the adjuster's identity is verified to a reasonable certainty based on an identification datum spoken by the adjuster. In some embodiments, the user authorization module 150 is integrated with the IVR device 108. In other embodiments, the user authorization module 200 is integrated with the VAD device 116. In still other embodiments, different levels of user authorization are provided at both the IVR device 108 and VAD device 116. Providing the user authorization module 200 in the VAD device 116 allows for additional security within the system. For example, more information is typically known about an adjuster at the VAD device 116 than at the IVR 108, which is often, but not always, an external device. As another example, the VAD device 116 also includes a security module 196. Private data related to insurance adjusters, claims, and other company confidential information can be encrypted prior to storage in a respective memory repository. Also, the security module may provide a firewall, anti-hacking technology, and other network security functions.

At least one claim number is associated with each insurance claim processed by the wireless, voice enabled database management tool 300. The claim number allows the tool to isolate information of one insurance claim from the information of other insurance claims. Additionally, the claim numbers permit the linking of information from one or more insurance claims to the information of one or more other insurance claims. In some cases, the claim number is generated by an external insurance provider entity and passed into the wireless, voice enabled database management tool 300. In other cases, claim numbers are generated internally by the VAD engine 170 or some other module in the database management tool 300. Relationships of linked claim numbers will also be provided in such cases.

A claim number authorization module 198 is provided to validate claim number information provided by an insurance adjuster during a telephone call. The authorization module 198 validates the existence of the claim number and provides further checking. For example, the claim number authorization module 198 may check that the adjuster is approved to provide or request information related to the claim. The claim number authorization module 198 may check that the insurance claim is ripe to be worked on, and the present status of the insurance claim may determine which one or more templates & scripts are presented to the adjuster. The claim number authorization module 198 may further trigger additional authorization acts, updating of claim related information, and synchronization of data across several systems.

The VAD engine 170 includes a user interface 194. The user interface provides structure through which an outside entity accesses data available within or via the VAD engine 170. The user interface 194 may provide, for example, an Internet Protocol (IP) based interface or another wired or wireless interface (e.g., USB, Bluetooth, etc.). Outside entities pass requests to store, retrieve, or modify data that is associated with the VAD device 116 through the user interface 194.

Embodiments of the VAD device 116 include a voice activated database (VAD) portal 202. The VAD portal 202 physically or logically provides modules configured to store, retrieve, and modify data through the user interface 194. The VAD portal 202 is the system through which typical VAD users, apart from adjusters, interact with the wireless, voice enabled database management tool 300. Through the VAD portal, a user can replay recorded audio, replay templates, review generated claim reports, and perform many other actions on data stored in the database system 158.

The VAD portal 202 of FIG. 3 includes a manager/administrator interface 204, a report generation module 206, and a test and proof module 206.

The manager/administrator interface 204 permits managers and users to access transcripts and recordings for export, copying, replay, modification, and many other functions. Managers may be permitted to review transcripts, listen to audio, make comments and associate the comments with certain audio or transcripts, approve or reject the transcripts, and perform other managerial functions. Typically, users and managers have assigned different permissions or “access levels” in the VAD device 116, and the different access levels control what information is available for access to a manager or user and what actions can be performed on the information.

The information and action privileges available to a particular manager or user are based on an access level granted to the manager or user. Embodiments of the VAD device 116 provide for a system of different access levels. The access levels determine the permission that users of a particular access level have to read, store, modify, and delete certain information. The tiered approach of the provided access levels improves security with the VAD device 116. In one embodiment, the access levels are manifested as three types of users: super-users, having full control over all information in VAD device 116; managers, having control over certain areas; and VAD team members, having access to transcripts for certain departments or claims. The VAD team member access may be granted access based on ranges of claim numbers, types of claims, geography, claims from certain adjusters, and many other ways. Managers and super users may have sufficient privilege to add, remove, and edit adjuster/administrator profiles.

The VAD portal 202 may deliver menus that are displayed to managers and users via a web interface, for example. The menus chosen to be displayed and the information to be displayed on a menu are in some cases based on the access level of the manager or user. The functions and modules of the VAD portal 202 can be accessed by a manager or user via the menus.

The manager/administrator interface 204 includes a database search feature. A manager or user is able to mine the VAD device 116 memory or database system 158 for particular information. The manager or user is able to access a list of claims assigned to an adjuster or a list of adjusters based on a name, ID, or other data. The manager or user can search for transcripts currently open in the system or audio recordings associated with the transcript. Search results produced via the search feature only show details that are permitted by the manager or user's access level. In some embodiments, managers have permission to view all recordings which are in their department or all recordings in the system, retrieve a particular transcript and its associated audio, playback the audio, add comments to a transcript for future reference, email a transcript or audio file, add adjusters, remove adjusters, edit adjuster profiles, and perform other actions. In some embodiments, the manager has access to all of the data in the database including raw audio recording data, processed data, digital input data, and other data.

The VAD portal 202 includes a report generator module 206. The report generator module 206 produces many different types of reports. Some reports are produced for business consideration by the office 140. Other reports, such as electronic insurance claim reports 120, are produced for insurance providers that administer claims management devices 118₁-118_{N}. Reports for the office 140 include error reports, work reports, VAD team timesheets, adjuster reports, call parameter reports, and the like. The reports can then be used to identify adjusters with high error rates, types of claim information that is likely to produce errors, and for other purposes. The business consideration reports can be used to identify reasons for certain error rates and steps can be taken to reduce errors in the future.

In one embodiment, an error report optionally includes information identified in Table 2.

TABLE 2
Error Report Information
Error Report Information

| | |
|---|---|
| 1. | The number of errors per transcript as a percentage of the |
| | total word count. |
| 2. | The number of errors per adjuster as a percentage of the |
| | total word count. |
| 3. | Daily, Weekly, Monthly, Custom reports per adjuster. |
| 4. | The number of transcripts handled per VAD Team member. |
| 5. | Daily, Weekly, Monthly, Custom VAD Team reports. |
| 6. | Time sheet per user. |

In one embodiment, a maintenance and training report optionally includes information identified in Table 3.

TABLE 3
Maintenance & Training Report Information
Maintenance & Training Report Information

| | |
|---|---|
| 1. | Reports from the telephony system on: |

| | |
|---|---|
| a. | Number of calls per day, week, month or a period. |
| b. | Call parameters. |
| c. | System performance and load capacity. |
| d. | Peak period identification. |

| | |
|---|---|
| 2. | Custom reports which can be generated to show information on: |

| | |
|---|---|
| a. | Total transcripts per day, week, month or a period. |
| b. | Total calls per adjuster. |
| c. | Total errors per defined period. |
| d. | Total errors per adjuster. |
| e. | Total transcripts done per administrator. |

| | |
|---|---|
| 3. | Error reports to show information on: |

| | |
|---|---|
| a. | Most commonly misunderstood words. |
| b. | Most commonly misunderstood phrases. |
| c. | Templates with most errors. |
| d. | Adjusters whose transcripts have a higher |

percentage of errors.

The maintenance and training reports can be used by a maintenance team to identify reasons for the errors, and the team can create processes to solve the problems. In certain cases, for example where a particular adjuster is found to have a higher error rate than expected, a maintenance team member or manager can listen to the adjuster's original audio. Causes for certain errors may include background noise, speed of speech, call quality, and other reasons that can be a cause of the problem. In such cases, the raw or quantified data from the maintenance and training report can be used to train the voice recognition server 112 on frequently misunderstood words. Such corrections improve the efficiency of the wireless, voice enabled database management tool 300 and help to achieve higher accuracy for those words. Certain words/phrases can be industry specific, and these words can be identified to better train the system.

In some cases, reports may consist of a single file in a portable document format (PDF) or some other format. The report may include relevant and most often used information available for a claim. The report may include a transcript of the voice data. The report can be sent to the adjuster via email.

A test and proof module 208 is provided to check a transcript against the actual recorded audio from a call and information retrieved from a VAD device 116 memory or the database system 158. The test and proof module 208 accesses the selected data by passing requests into the claims files memory 186 or database system 158, which return the selected data after passing authentication and security measures. Once corrected (if necessary) and approved, transcripts may be sent back to the claims files memory 186 or database system 158 for storage, and the transcript may further be provided as feedback for the voice recognition training module 112b in the voice recognition module 112.

Managers are typically granted access to test and proof data produced by the test and proof module 208. The managers supervise the VAD team that performs transcript verification. The managers also supervise adjuster's compliance reporting.

The test and proof module 208 provides an interface that allows a VAD team to check transcripts created by the voice recognition server 112 from an audio data stream or voice file that has been input by an adjuster. In one embodiment, the test and proof module 208 is browser based and integrated with the security access levels defined in the VAD device 116.

In an embodiment, the test and proof module 208 includes a transcript list area, a database information area, a transcribed text area, an audio player, and a template preview area.

The transcript list area of the test and proof module 208 is the interface that a user will see when first logging on to a VAD portal 202. The transcript list area will display some or all of the transcripts that are waiting for approval. The transcripts are displayed in a convenient manner such as placing each transcript on a separate row with information regarding the transcript also displayed in the row. A user of the VAD portal 202 can select one or more of the transcripts from this transcript list area for further review and processing.

The database information area of the test and proof module 208 displays particular information about a selected transcript. The information generally includes information that identifies the adjuster associated with the transcript, the claim, and details associated with the insured. The information is retrieved from memory of the VAD device 116 or the system database 158. The user of the VAD portal 202 can cross check the information in the transcribed text against the correct information from the memory/database. Additionally, the database information area displays scheduled actions such as letters, pack requests, scheduled automated calls, and the like as well as historical information related to the claim and other scheduled actions.

The transcribed text area of the test and proof module 208 shows text that has been transcribed from the audio input of the adjuster. In some embodiments, the text is shown as raw text and in additional or alternative embodiments the text is shown as answers embedded in an associated template. The user of the VAD portal 202 can correct text as needed and save the corrected text through the VAD portal 202 for further processing.

The audio player of the test and proof module 208 plays back the voice audio recorded during an adjuster call. The voice audio was recorded and processed via the voice recognition into a transcript. The recorded voice file is linked to the transcript and both the voice file and transcript are loaded by the test and proof module 208. The user of the VAD portal can listen to the audio and use the audio to validate or correct the transcribed text. The audio player has the usual controls such as play, pause, rewind, forward, and the like.

A complete template preview area of the test and proof module 208 displays an entire template for a particular transcript with the “blanks” filled in as expected. Options to edit the template are provided to the user of the VAD portal 202 before the template is approved and posted. The home screen may also display alerts for claims that are out of compliance so that appropriate action can be taken.

In an embodiment, an administrator is a user of the VAD portal 202. The administrator is tasked with the duty of reviewing voice and other data entered by an insurance claims adjuster during a previous adjuster initiated telephone call. The voice and other data entered by the adjuster corresponds with prompts for information in one or more templates that were presented to the adjuster during the telephone call.

The administrator logs into the VAD system 116 via the VAD portal 202 and sees the transcript list area. The administrator is presented with a list of transcripts that are ready to be checked. The administrator selects a transcript. The VAD portal 202 arrangement assigns the transcript to the administrator and retrieves the transcript and associated files via the database area. The transcript and files are locked so that no other user can access them. The administrator is presented with a transcribed text area, which will display the transcript selected. The transcribed text area shows information related to the adjuster that processed that claim, the details of the insured, the details of the claim, and other associated information. The transcribed text area enables the administrator to verify the details of the transcript. When the administrator encounters data that is suspected of having errors, the administrator can choose to operate the audio player to clarify that which has been transcribed and correct the data if necessary. The administrator is able to navigate to the complete template preview area, which will show the template form having information filled exactly as the form will be posted. After completing corrections and verifying the information associated with the transcript, the administrator saves the transcript and other associated, and updates files back to the VAD device 116. Subsequently, from the saved data, an electronic insurance claim report is generated for communication to a claims management device 118₁-118_{N}.

FIG. 4 is a flowchart 220 illustrating acts corresponding to operations of the wireless, voice enabled database management tool 300 of FIG. 3. The flowchart of FIG. 4 illustrates one embodiment of an interactive use of the database management tool 300 of FIG. 3.

At 222, a claims management device 118₁-118_{N} generates a request for an electronic insurance claim report 120 (e.g., ALLSTATE L300 loss notice report form). The request is generated as a result of a calamity reported to an insurance provider. The request is passed to a voice enabled database management tool 300, and in particular to a voice activated database (VAD) device 116. The insurance provider or VAD 116 identifies a particular insurance adjuster 102 either specifically or via an entity that provides insurance adjustment services through association with particular insurance adjusters. The request for a loss notice report is sent to the insurance adjuster 102 as email, fax, short messaging service (SMS) text message, automated telephone call, or by some other means.

At 224, upon receiving the request for the electronic insurance claim report 120, the insurance adjuster 102 calls in to an interactive voice response (IVR) device 108 to start the claim report process. The insurance adjuster 102 typically uses a mobile device 104 to make the call, and often, the adjuster 102 is at the site of the calamity when the call is made. At 226, The IVR device 108 takes action to verify the identity of the insurance adjuster 102 with reasonable certainty. In some embodiments, the IVR 102 uses a caller ID feature to validate the known telephone number of the insurance adjuster's mobile device 104. In other embodiments, a user authentication module 150 (or user authentication module 200 of VAD 116) is employed to provide further verification. For example, the insurance adjuster 102 may be requested to enter a personalized identification number (PIN), an alternate phone number, an identification number, a biometric information signal, or by some other means. In some embodiments, the identification number is a 7 digit user ID generated at the time of creation of adjuster accounts.

At 228, the insurance adjuster 102 enters a claim number. The claim number is typically identified in the original request for the insurance claim report at 222, but other means of identifying or generating the claim number may also be used. In some cases, the claim number is entered via a keypad on the mobile device 104 and passes through a DTMF module 156 of the IVR 108. In some cases, the claim number is spoken by the insurance adjuster 102 and interpreted by modules of a voice recognition server 112. In still other cases, the claim number is input as digital information passed by some other means to the IVR 108.

Attempts to validate the claim number are made at 230. If the claim number is not validated, the connected call may be terminated. Alternatively, a connected call may be passed to a human operator for additional problem resolution. On the other hand, if the claim number is validated, the voice activated database (VAD) engine 170 provides the insurance adjuster 102 with access to a wide variety of services. A validated claim number is typically a claim number that has been expressly assigned to the insurance adjuster 102. This permits the system to keep track of insurance adjuster workloads, quality, and other features accessible by cross-referencing the adjusters with their assigned claim numbers.

At 246, the insurance adjuster can begin taking action according to particular templates. A particular template may be selected specifically by the insurance adjuster 102 or the template may be selected automatically based on previous inputs to the system. Within the VAD 116, the template handler 192 administers the template selection process and issues templates from a pool of available claim script templates 190. The templates may be stored according to particular template ID numbers, template ID names, or by some other system. In such cases, the adjuster may know the number or identifying characteristics of a certain template, and the adjuster can ask for the certain template. In other cases, based on the claim number and adjuster identify, the system may have flagged certain templates for incorrect or incomplete processing, and the system can automatically retrieve and begin processing according to a particular template as described herein.

In some cases, the insurance adjuster 102 has other business with the wireless, voice enabled database management tool 300, or the adjuster is not yet ready to begin claims processing via the templates. In such cases, the adjuster 102 can access other available services. For example, at 232, certain menus may be produced and spoken by a speech synthesis module 154. The spoken menus will typically identify services available to the adjuster.

At 240, one service available to the adjuster 102 is the generation of a blank electronic insurance claim report. At 242, another available service is a scheduling service. The scheduling service can be arranged to call back the adjuster, call another party to deliver an automated message, set appointments, or perform other scheduling functions. In still other cases, at 244 for example, additional services may be accessed by the adjuster 102.

If the adjuster would like additional help, the adjuster can indicated the request for help at 234, and at 236 and 238 respectively, a human operator can be connected or a set of instruction tips for using the system can be presented. Typically, the instruction tips are provided interactively based on inputs provided by the adjuster.

Returning to the template handler processing, general template questions are spoken at 248 and heard by the adjuster 102. The speech synthesis module 154 of the IVR 108 includes performs the task of reading text in the template that prompts the adjuster for input. A speech recognition module 112a converts spoken input from the adjuster into text. In the system, the adjuster answers each question appropriately in natural speech (or via key press or some other input means) and the answers are transcribed. Later, the adjuster may be provided with the option to review the recorded audio and re-record answers.

The template handler 192 of the VAD 116 may issue many different templates of many different types. The flowchart of FIG. 4 illustrates several categories of template prompts. For example, at 250, the adjuster may be asked specific questions, and at 252, the adjuster may be requested to provide a detailed narrative report. At 254, particular trigger questions may be asked, and at 256, certain actions may be prompted. The responses to the spoken template prompts may include yes/no answers, numerical answers, or other answers. The VAD 116 is prepared to accept keypad input, voice input, or other input.

In cases where actions are prompted (i.e., act 256), an automatic scheduling function 262 may be called upon. The automatic scheduling function 262 may be the same or similar to the automated call scheduler 242, or it may be completely separate and different. Other actions may also be prompted, for example, certain functions can be triggered such as an email system, a review system, or a new template can be launched. A database update can be triggered, a calendar update can be triggered, or a call can be scheduled. In still other cases, via the trigger action at 254 for example, an information packet can be scheduled for electronic or physical delivery. Still other actions can also be triggered.

In response to actions that include voice input from the adjuster, the speech information is transcribed at 258. Consideration for further processing is made at 264, and either further processing is started or the call ends at 266. Upon completion of the call, the transcript is reviewed at 268, and errors are logged at 270. A final report/transcript is prepared at 272, and processing ends at 274.

As described herein, the VAD 116 includes modules configured for the tasks of the flowchart of FIG. 4. For example, the validation of the claim number at 230 is administered by a claim number authorization module 198. In response to particular template entries, the template handler 192 may access the question/answer module 182, the decision module 184, the action handler 178, the error handler 180, and other modules as well. The system repeats the actions of the FIG. 4 flowchart until an End condition of a template is encountered. The system can then disconnect the adjuster from the call with a predefined message. Subsequently, after the transcript is reviewed and processed, the decoded text transcript can be stored in the database system 158.

FIGS. 2B and 4 are flowcharts illustrating processes that may be used by embodiments of the wireless, voice enabled database management tool. In this regard, each described process may represent a module, segment, or portion of code, which comprises one or more executable instructions for implementing the specified logical function(s). It should also be noted that in some implementations, the functions noted in the process may occur in a different order, may include additional functions, may occur concurrently, and/or may be omitted.

FIG. 3 illustrates portions of a non-limiting embodiment of a computing device. The computing device includes operative hardware found in a conventional computing device apparatus such as one or more central processing units (CPU's), volatile and non-volatile memory, serial and parallel input/output (I/O) circuitry compliant with various standards and protocols, wired and/or wireless networking circuitry(e.g., a communications transceiver).

As known by one skilled in the art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to executed by a CPU.

The computing device further includes operative software found in a conventional computing device such as an operating system, software drivers to direct operations through the I/O circuitry, networking circuitry, and other peripheral component circuitry. In addition, the computing device includes operative application software such as network software for communicating with other computing devices, database software for building and maintaining databases, and task management software for distributing the communication and/or operational workload amongst various CPU's. In some cases, the computing device is a single hardware machine having the hardware and software listed herein, and in other cases, the computing device is a networked collection of hardware and software machines working together in a server farm to execute the functions of the wireless, voice-enabled database management tool 300. Some aspects of the conventional hardware and software of the computing device is not shown in FIG. 3 for simplicity.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic insurance claim report method, comprising:
configuring an interactive voice response (IVR) system to:
receive a telephone call from a remote device;
deliver, to the remote device, an audio script having prompts in response to the received telephone call and in further response to data received from the remote device, the prompts associated with an insurance claim report generation template; and
receive at least one of dual-tone, multi-frequency (DTMF) signaling tone information and human voice information in response to the prompts;
configuring a voice recognition server to generate text from human speech, the voice recognition server having access to a dictionary that includes insurance relevant terms;
configuring a voice activated database (VAD) device to:
receive first digital information from the IVR system, the first digital information derived from the DTMF signaling tone information or receive second digital information from the voice recognition server, the second digital information derived from the human voice information passed through the voice recognition server; and
generate the electronic insurance claim report from at least some of the first or second digital information; and
communicating the electronic insurance claim report to a claims management device.

2. The method of claim 1 wherein the interactive voice response (IVR) system is configured to:
authenticate a user of the remote device based on a spoken identification number.

3. The method of claim 2 wherein the interactive voice response (IVR) system is configured to:
authenticate the user of the remote device by comparing the spoken identification number to adjuster information imported from a database.

4. The method of claim 1 wherein the interactive voice response (IVR) system is configured to:
generate scripted voice prompts with a speech synthesis engine; and
output the scripted voice prompts to the remote device.

5. The method of claim 4 wherein the scripted voice prompts are generated according to a stored template.

6. The method of claim 1 wherein the interactive voice response (IVR) system is configured to:
store the received DTMF signaling tone information and the received human voice information in a database system.

7. The method of claim 1 wherein the voice recognition server is configured to:
process naturally spoken language in real time.

8. The method of claim 1 wherein the voice activated database (VAD) device is configured to:
carry out one or more of trees, conditional logic, state machines, and script driven processes on the DTMF signaling tone information.

9. The method of claim 1 wherein the voice activated database (VAD) device is configured to:
receive a request to process a new claim from the claims management device.

10. The method of claim 1 wherein the voice activated database (VAD) device is configured to:
execute a visual template design function;
accept input text configured to be applied to a speech synthesis engine; and
create a second insurance claim report generation template using the visual template design function and the input text.

11. An insurance claim report generating system, comprising:
an interactive voice response (IVR) system configured to receive a telephone call from a remote device, deliver an audio script having prompts directed by both an insurance claim report generation template and data received from the remote device, and receive at least one of dual-tone, multi-frequency (DTMF) signaling tone information and human voice information in response to the prompts;
a voice recognition server configured to generate text from the human voice information, the voice recognition server having access to a dictionary of insurance relevant terms; and
a voice activated database (VAD) device configured to receive at least one of first digital information from the IVR system and second digital information from the voice recognition server, the first digital information derived from the DTMF signaling tone information and the second digital information derived from the human voice information passed through the voice recognition server, the VAD device further configured to generate an insurance claim report from at least some of the first or second digital information.

12. The insurance claim report generating system of claim 11 wherein the interactive voice response (IVR) system includes:
a database system arranged to store at least one of received DTMF signaling tone information and received human voice information.

13. The insurance claim report generating system of claim 12 wherein the interactive voice response (IVR) system is configured to:
receive a spoken identification datum from a user of the remote device and authenticate the user of the remote device by comparing the spoken identification datum to adjuster information imported from the database system.

14. The insurance claim report generating system of claim 12 wherein the voice activated database (VAD) device includes:
a VAD portal arranged to replay the stored human voice information.

15. A non-transitory computer readable storage medium whose stored contents configure a computing system to perform a method, the method comprising:
receiving a telephone call from a remote device;
delivering, to the remote device, an audio script having prompts in response to the received telephone call and in further response to data received from the remote device, the prompts associated with an insurance claim report generation template;
receiving at least one of dual-tone, multi-frequency (DTMF) signaling tone information and human voice information in response to the prompts;
generating, with a voice recognition server, text from human speech, the voice recognition server having access to a dictionary that includes insurance relevant terms;
receiving at least one of first digital information derived from the DTMF signaling tone information and second digital information from the voice recognition server, the second digital information derived from the human voice information passed through the voice recognition server; and
generating an electronic insurance claim report from at least some of the first or second digital information.

16. The non-transitory computer readable storage medium according to claim 15 whose stored contents configure the computing system to perform the method, the method further comprising:
communicating the electronic insurance claim report to a claims management device.

17. The non-transitory computer readable storage medium according to claim 15 whose stored contents configure the computing system to perform the method, the method further comprising:
storing at least one of the received DTMF signaling tone information and received human voice information in a database system.

18. The non-transitory computer readable storage medium according to claim 17 whose stored contents configure the computing system to perform the method, the method further comprising:
receiving a spoken identification datum from a user of the remote device; and
authenticating the user of the remote device by comparing the spoken identification datum to adjuster information imported from the database system.

19. The non-transitory computer readable storage medium according to claim 17 whose stored contents configure the computing system to perform the method, the method further comprising:
replaying the human voice information stored in the database system.

20. The non-transitory computer readable storage medium according to claim 15 whose stored contents configure the computing system to perform the method, the method further comprising:
executing a visual template design function;
accepting input text configured to be applied to a speech synthesis engine; and
creating a second insurance claim report generation template using the visual template design function and the input text.
